(19) United States
(12) Patent Application Publication
(10) Pub. No.: US 2023/0302555 A1
(43) Pub. Date: Sep. 28, 2023

(54) SAW DEVICE, STACK ARRANGEMENT, COVER ARRANGEMENT, TRANSPORT ARRANGEMENT AND METHOD

(71) Applicant: FESTOOL GMBH, Wendlingen (DE)

(72) Inventors: Philipp EISENMANN, Bissingen (DE); Sibylle RAPP, Eislingen (DE)

(21) Appl. No.: 18/162,284

(22) Filed: Jan. 31, 2023

(30) Foreign Application Priority Data
Feb. 3, 2022 (DE) 10 2022 201 168.6

(51) Int. Cl. B23D 47/02; B25H 3/02; B23D 57/00

(52) U.S. Cl. CPC B23D 47/025; B23D 57/0092; B25H 3/02

(57) ABSTRACT

A saw device, in particular a circular table saw or a miter saw, including a saw unit with a saw blade and a support structure, which can be placed with its underside on a base and has a workpiece support on which a workpiece can be placed while it is being sawn with the saw device. The saw device has a coupling interface via which a releasable, vertically tension-proof coupling with at least one system box can be produced in order to form a vertical stack together with the at least one system box in such a way that the saw device assumes a transport orientation in the vertical stack in which transport orientation the workpiece support is vertically oriented with its support plane.

This application claims priority to German application 10 2022 201 168.6, filed Feb. 3, 2022, which is incorporated by reference.

The invention relates to a saw device, in particular a circular table saw or a miter saw, comprising a saw unit with a saw blade and a support structure which can be placed with its underside on a base and has a workpiece support on which a workpiece can be placed while being sawn with the saw device, the saw device having a coupling interface via which a releasable, vertically tension-proof coupling with at least one system box can be established in order to form a vertical stack together with the at least one system box.

The system box is, for example, a transport box. Expediently, the system box has a system box coupling interface with which the system box can be coupled to at least one further system box in order to form a vertical stack with the further system box. In particular, a vertically tension-proof coupling is a coupling that transmits a vertical tensile force.

US8602378B2 describes a stand that folds into a hand truck with a portable table saw attached to the support surface of the stand.

WO2018065042A1 describes a transportable circular saw in the form of a system box that can be integrated into a stack of system boxes and transported together with them. Here, the transportable circular saw can be integrated into a stack of system boxes in working orientation, i.e. with its working table oriented horizontally.

### SUMMARY OF THE INVENTION

It is an object of the invention to provide an easily transportable and flexibly usable saw device.

The object is solved by a saw device according to the claims. The saw device has the coupling interface via which the releasable, vertically tension-proof coupling with the at least one system box can be produced in order to form the vertical stack together with the at least one system box in such a way that the saw device assumes a transport orientation in the vertical stack in which transport orientation the workpiece support is oriented vertically with its support plane.

The horizontal dimensions of a system box are predefined so that the system box is compatible with other system boxes of the same system. A system box may also be referred to as system crate. In order to design the saw device in such a way that it can be coupled to a system box, the saw device must be dimensioned according to the horizontal dimensions - i.e. the ground plan or footprint - of the system box. Conventionally, a saw device is designed in such a way that it can be accommodated in the vertical stack in working orientation - i.e. with a horizontally oriented workpiece support. In this case, the size of the workpiece support is limited by the horizontal dimensions of the system box.

According to the invention, the saw device can be accommodated in the vertical stack in the transport orientation - i.e. with a vertically oriented workpiece support. This means that the length of the workpiece support is no longer limited by the horizontal dimensions of the system box. It becomes possible to provide a saw device with a workpiece support that is longer than the horizontal dimensions of the system box but can still be coupled to the system box to form a vertical stack. Due to the enlarged workpiece support, the saw device can be used more flexibly; at the same time, the saw device can still be accommodated in a stack of system boxes and can therefore be easily transported.

Advantageous further developments are the subject of the dependent claims.

The invention further relates to a stack arrangement comprising the saw device, and a lower system box and/or an upper system box, wherein the saw device is mounted on the lower system box and/or the upper system box is mounted on the saw device such that the saw device, the lower system box and/or the upper system box together form a vertical stack, and wherein the coupling interface comprises a lower coupling interface providing a lower releasable, vertically tension-proof coupling to the lower system box and/or comprises an upper coupling interface providing an upper releasable, vertically tension-proof coupling to the upper system box, wherein the saw device in the vertical stack assumes the transport orientation in which the workpiece support is vertically oriented with its support plane.

The invention further relates to a method of operating the saw device, comprising the step of: establishing the releasable, vertically tension-proof coupling between the saw device and the at least one system box such that the saw device and the at least one system box form the vertical stack such that the saw device assumes a transport orientation in the vertical stack in which the workpiece support is vertically oriented with its support plane.

The invention further relates to a cover arrangement with a cover structure designed as a protective hood for receiving a power tool, in particular a circular table saw or a miter saw, wherein the protective hood has a coupling interface with which a releasable, vertically tension-proof coupling to one or more system boxes can be established, so that the cover arrangement can form, in a transport configuration in which the protective hood accommodates the power tool, a vertical stack together with the one or more system boxes.

The invention further relates to a transport arrangement comprising the cover arrangement as well as the power tool accommodated in the protective hood, wherein the transport arrangement has coupling sections for establishing the releasable, vertically tension-proof coupling, in particular a/the lower releasable, vertically tension-proof coupling and/or an/the upper releasable, vertically tension-proof coupling, which coupling sections are part of the coupling interface, wherein all coupling sections are part of the protective hood and not part of the power tool.

The invention further relates to a stack arrangement comprising the transport arrangement and a lower system box and an upper system box, wherein the transport arrangement is mounted on the lower system box and the upper system box is mounted on the transport arrangement such that the transport arrangement, the lower system box and the upper system box together form a vertical stack, and wherein the coupling interface comprises a lower coupling interface providing a lower releasable, vertically tension-proof coupling to the lower system box and an upper coupling interface providing an upper releasable, vertically tension-proof coupling to the upper system box.

The invention further relates to a method of operating the cover arrangement or the transport arrangement, comprising the step of: establishing the releasable, vertically tension-proof coupling of the protective cover to the at least one system box to form the vertical stack.

### BRIEF DESCRIPTION OF THE DRAWINGS

Further exemplary details as well as exemplary embodiments are explained below with reference to the figures. Thereby shows

FIG. 1 a perspective view of a saw device,

FIG. 2 a schematic representation of the saw device in a transport configuration,

FIG. 3 a perspective view of a stack arrangement,

FIG. 4 a sectional view of an upper coupling recess of a coupling interface,

FIG. 5 a sectional view of a rotary latch of the coupling interface,

FIG. 6 a sectional view of a lower coupling protrusion of the coupling interface,

FIG. 7 a sectional view of a front coupling protrusion of the coupling interface,

FIG. 8 the saw device in a working configuration,

FIG. 9 a multi-part cover structure,

FIG. 10 a sectional view of an internal coupling structure of a cover structure,

FIG. 11 a cover arrangement comprising a cover structure and a bottom element attachable to the cover structure.

### DETAILED DESCRIPTION OF THE INVENTION

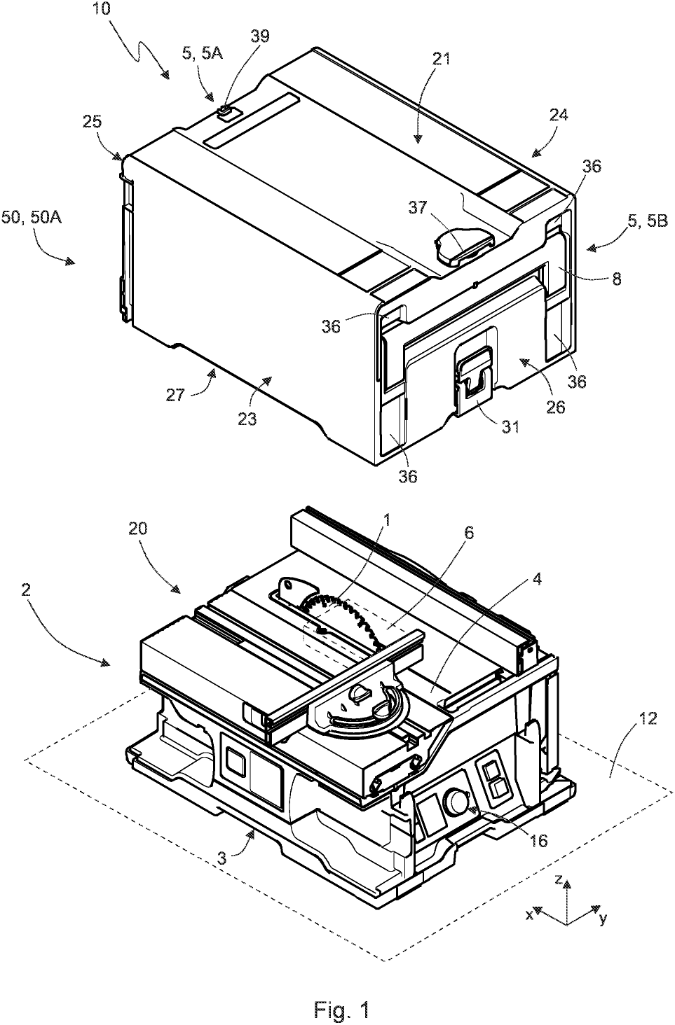

FIG. 1 shows a saw device 10, which is exemplarily designed as a table saw. The saw device 10 can also be designed as a miter saw. A miter saw may also be referred to as cross-cut saw.

The saw device 10 is preferably a semi-stationary machine. A semi-stationary machine is a machine that must be positioned stationary on a base for processing a workpiece and/or a machine that can be carried by a single user. Exemplarily, the saw device 10 must be positioned stationary on a base 12 for sawing a workpiece 6 and/or can be carried by a single user. For example, the saw device weighs less than 30 kg and/or has (in a transport configuration and a transport orientation) a floor plan (e.g. a footprint) of less than 50 cm × 50 cm.

In an exemplary embodiment, the saw device 10 comprises a saw unit 20 and a cover structure 50. Expediently, the saw unit 20 already represents a circular table saw in itself. The saw unit 20 may also be designed as a miter saw. The cover structure 50 is exemplarily designed as a cover hood, in particular as a protective hood, for the saw unit 20.

Reference is made below to the x-direction, y-direction and z-direction shown in the figures, which directions are oriented orthogonally to one another. The x-direction, y-direction and z-direction refer to the saw device 10 and are therefore rotated accordingly when the saw device 10 is rotated.

The x-direction may also be referred to as the longitudinal direction. Exemplarily, the x-direction is the feed direction in which a workpiece 6 is pushed onto a saw blade 1 of the saw device 10 in order to saw the workpiece 6 with the saw blade 1. The y-direction may also be referred to as the transverse direction. The y-direction is oriented perpendicular to the plane of the saw blade 1. The z-direction is oriented perpendicular to a support plane of a workpiece support 4 of the saw device 10.

Preferably, the saw device 10 can be selectively set in a working configuration or a transport configuration.

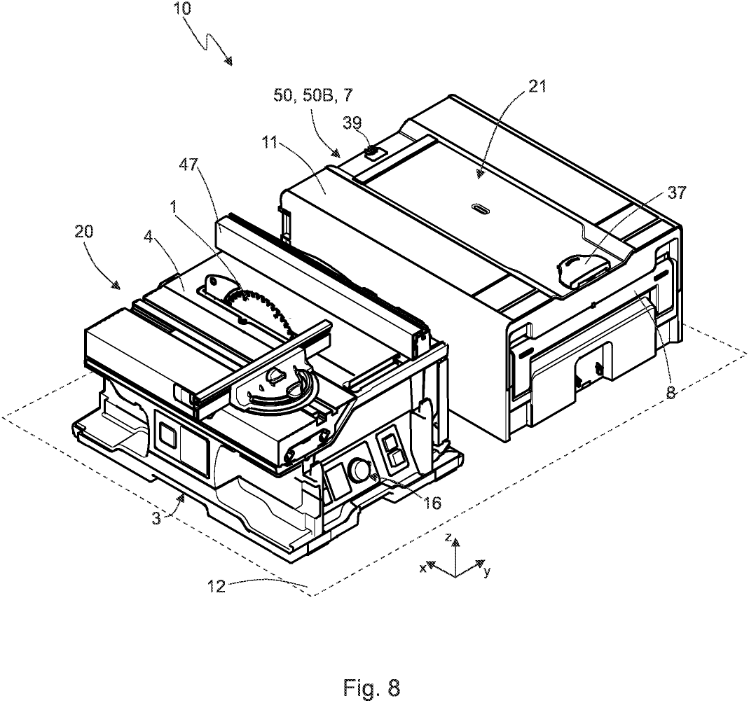

The working configuration is shown, for example, in FIG. 1 and FIG. 8. In the working configuration, the saw unit 20 can be used for sawing the workpiece 6. In the working configuration, the cover structure 50 does not cover the workpiece support 4 and/or does not cover the saw blade 1. For example, in the working configuration, the cover structure 50 is removed from the saw unit 20. Preferably, the cover structure 50 is positioned adjacent to the saw unit 20 in the working configuration, as exemplified by FIG. 8. The saw device 10, in particular the saw unit 20, can be put into a working orientation. In the working orientation, the x-direction and the y-direction are oriented horizontally and the z-direction is oriented vertically.

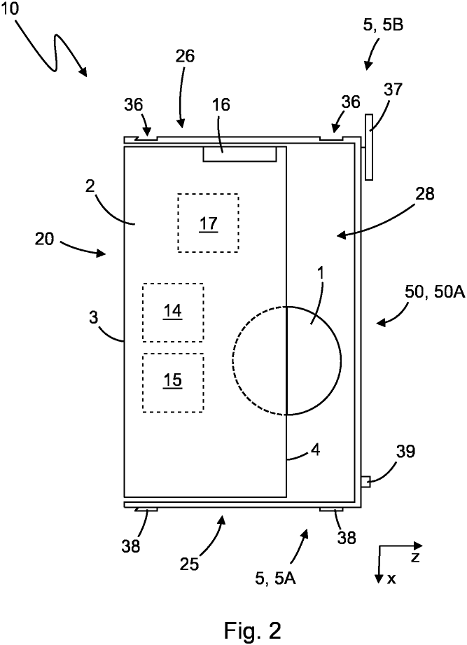

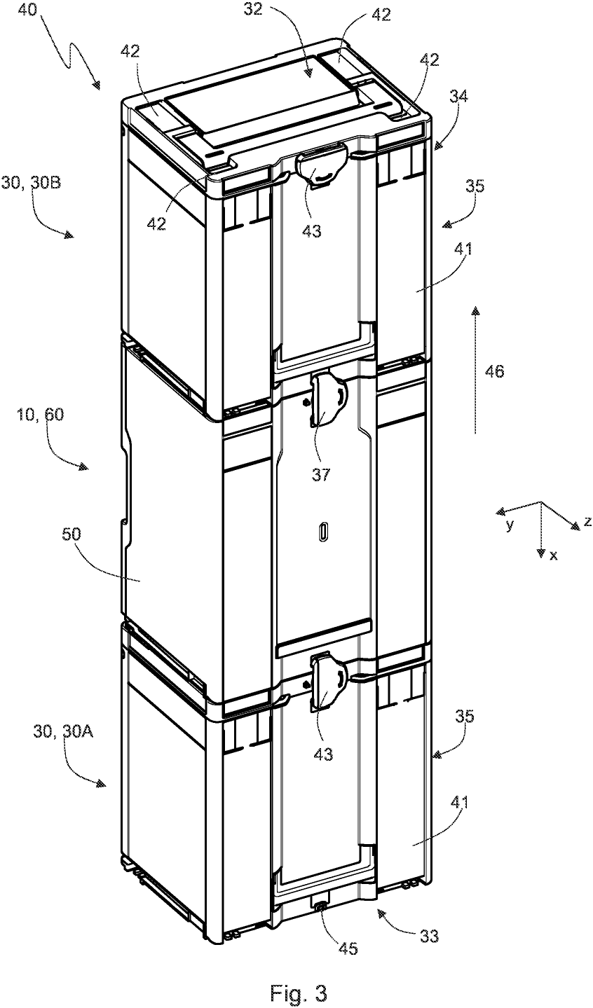

The transport configuration is shown, for example, in FIGS. 2 and 3. In the transport configuration, the saw device 10 can be (or is) housed in a stack of system boxes 30. In the transport configuration, the cover structure 50 covers the workpiece support 4 and/or the saw blade 1. In particular, in the transport configuration, the cover structure 50 is attached to, exemplarily placed on, the saw unit 20. For example, the cover structure 50 accommodates the saw unit 20 in the transport configuration. The saw device 10, in particular the saw unit 20, can be put into a transport orientation. In the transport orientation, the y-direction and the z-direction are oriented horizontally and the x-direction is oriented vertically. In the transport orientation, the saw unit 10 is rotated relative to the working orientation, namely by 90 degrees about a horizontal axis, in particular a horizontal axis extending in the y-direction. Expediently, in the transport configuration, the saw blade 1 is operatively (e.g. so that it is ready for operation) attached to the support structure 2 and protrudes from the workpiece support 4.

Exemplarily, the saw device 10 is box-shaped, in particular cuboid-shaped, especially in the transport configuration. Preferably, in the transport configuration, the saw device 10 has the external shape of a system box.

The saw unit 20 comprises the saw blade 1, which is exemplarily designed as a circular saw blade.

The saw unit 20 further comprises a support structure 2, which, in an exemplary embodiment, can be placed with its underside 3 on the base 12. The base 12 is, for example, a work surface, in particular the upper side of a work table or a workbench. The base 12 may also be referred to as support or underlay. Exemplarily, the support structure 2 has a cuboidal basic shape. In particular, the support structure 2 provides the outer housing of the saw unit 20.

The saw unit 20 has a workpiece support 4 on which the workpiece 6 can be placed, in particular while it is being sawn with the saw device 10. Exemplarily, the workpiece support 4 is the upper side of the support structure 2. In particular, the workpiece support 4 is a workpiece support surface. The saw blade 1 projects out of the workpiece support 4 in the z-direction and/or can project into it (in the negative z-direction). In the working orientation, the support plane of the workpiece support 4 is oriented horizontally - i.e. perpendicular to a vertical direction - and in the transport orientation, the support plane of the workpiece support is oriented vertically - i.e. perpendicular to a horizontal direction. The support plane is an x-y plane.

The saw unit 20 has a drive unit 14 for driving the saw blade 1. The drive unit 14 comprises, for example, an electric motor. Exemplarily, the drive unit 14 is arranged in or on the support structure 2. Exemplarily, the drive unit 14 can be arranged below or above the workpiece support 4.

Optionally, the saw unit 20 further comprises an adjustment unit 15 for adjusting an orientation and/or height of the saw blade 1 relative to the workpiece support 4. The adjustment unit 15 expediently comprises one or two electric motors.

Preferably, the saw unit 20 comprises an operating device 16 via which a user can control the drive of the saw blade 1 and/or set the height and/or orientation of the saw blade 1. Exemplarily, the operating device 16 is arranged on a peripheral side of the saw unit 20.

Preferably, the saw unit 20 comprises a control unit 17. In particular, the control unit 17 is configured to control the drive unit 14 and/or the adjustment unit 15, for example according to an input of a user into the operating device 16. Preferably, the control unit 17 comprises a microcontroller.

In an exemplary embodiment, the cover structure 50 is cuboid-shaped. In an exemplary embodiment, the cover structure 50 comprises a cover structure upper side 21 (oriented normal to the positive z-direction), a first cover structure longitudinal side 23 (oriented normal to the negative y-direction), a second cover structure longitudinal side 24 (oriented normal to the positive y-direction), a first cover structure transverse side 25 (oriented normal to the positive x-direction), and a second cover structure transverse side 26 (oriented normal to the negative x-direction). The sides 21, 23, 24, 25 and 26 are expediently closed sides. The sides 23, 24, 25, 26 shall also be referred to as peripheral sides or as circumferential sides.

In an exemplary embodiment, the cover structure 50 includes an open cover structure underside 27 through which the saw unit 20 can be received into the cover structure 50. In particular, the cover structure 50 can be slipped over the saw unit 20 with the open cover structure underside 27 leading, in particular in a negative z-direction, to place the saw device 10 in the transport configuration. The cover structure 50 with the open cover structure underside 27 is exemplarily designed as a protective hood, and shall in particular be referred to as cover structure 50A according to a first variant.

Expediently, the cover structure 50 covers the operating device 16 in the transport configuration. For example, the cover structure 50 has a peripheral side, for example the second cover structure transverse side 26, which covers the operating device 16 in the transport configuration.

Preferably, in the transport configuration, the peripheral sides - that is, in particular, the sides 23, 24, 25, 26 - of the cover structure 50 cover the peripheral sides (that is, in particular, the sides different from the workpiece support 4 and the underside 3) of the saw unit 20, in particular completely.

Preferably, in the transport configuration, the cover structure 50 defines an interior space 28 that is closed off from the environment of the saw device 10, in particular in a dust-tight manner. In the interior space 28, the saw blade 1 and/or the workpiece support 4 are expediently arranged. In particular, the workpiece support 4 and the saw blade 1 are protected by the cover structure 50 during transport. Expediently, the saw device 10 is accommodated in the cover structure 50 such that (in the transport configuration) dirt located in the saw device 10 or on the workpiece support 4 remains in the saw device 10 or in the interior space 28.

Preferably, the saw device 10 in the transport configuration has a in particular cuboid-shaped outer housing. Exemplarily, the outer housing is partially formed by the cover structure 50. Exemplarily, in the transport configuration, one side of the outer housing is formed by the underside 3 of the support structure 2 and all other sides of the outer housing are formed by the cover structure 50 - in particular by the sides 21, 23, 24, 25 and 26 of the cover structure 50. Expediently, the underside 3 is the contact surface (or footprint) of the saw unit 10. Preferably, the contact surface of the saw unit 10 forms the underside or bottom plate of the saw device 10, which is box-shaped in the transport configuration. In the transport configuration, the hood-shaped cover structure 50 is slipped over the saw unit 20, in particular to protect it, and is attached to the bottom plate, for example.

In an alternative embodiment of the cover structure, in the transport configuration, the outer housing of the saw device 10 is completely formed by the cover structure 50.

Exemplarily, the cover structure 50 has one or more cover structure fastening elements 31 for fastening the cover structure 50 to the saw unit 20, in particular in a state in which the cover structure 50 is slipped over the saw unit 20. For example, the cover structure 50 comprises as cover structure fastening element 31a fastening latch, which is exemplarily arranged on a peripheral side, in particular the second cover structure transverse side 26, preferably on the outside.

In an exemplary embodiment, the cover structure 50 includes a carrying handle 8 for carrying the saw device in the transport configuration. The carrying handle 8 is preferably arranged on the second cover structure transverse side 26, in particular on the outside. In an exemplary embodiment, the carrying handle 8 is bow-shaped (e.g. U-shaped). Expediently, the carrying handle 8 is designed to be foldable and can selectively be moved to a folded-in position or a folded-out position.

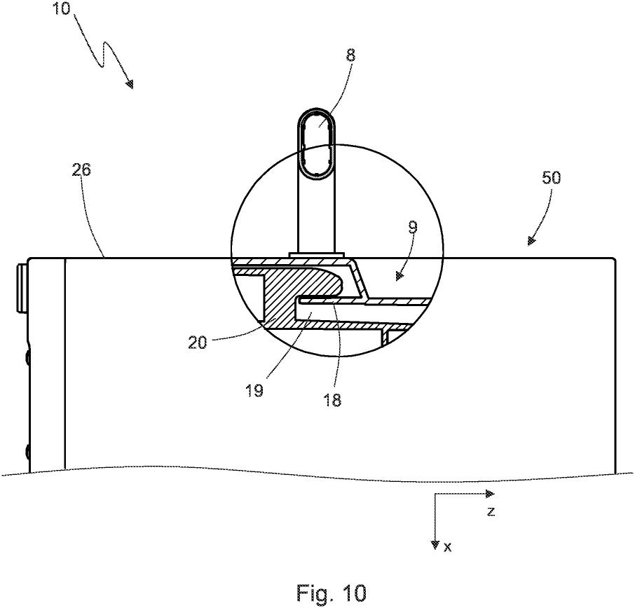

In an exemplary embodiment, the cover structure 50 comprises an internal coupling structure 9 by which the saw unit 20 is suspended from the cover structure 50 when the saw device 10 (in the transport configuration) is in the transport orientation. An exemplary embodiment of the inner coupling structure 9 is shown in FIG. 10. In particular, the inner coupling structure 9 comprises a hook structure 18 that engages a coupling recess 19 of the saw unit 20. Exemplarily, the inner coupling structure 9 is arranged internally on the second cover structure transverse side 26. Preferably, the carrying handle 8 is arranged in the region of the inner coupling structure 9 on the outside of the cover structure 50. In particular, the carrying handle 8 is arranged on the outside of the second cover structure transverse side 26, preferably (in the transport orientation) in the same horizontal region as the inner coupling structure. Exemplarily, the carrying handle 8 is arranged such that an imaginary straight line extending through the carrying handle 8 in the x-direction extends through the inner coupling structure 9, in particular through the hook structure 18. In particular, the carrying handle 8 is arranged in such a way that, in a state in which the saw device 10 is carried by the carrying handle 8, the weight force of the saw unit 20 is transmitted directly via the inner coupling structure 9 in an upward direction into the carrying handle 8.

The saw device 10 has a coupling interface 5. Via the coupling interface 5, the saw device 10 can be coupled to a system box 30. In particular, a releasable, vertically tension-proof coupling between the saw device 10 and at least one system box 30 can be established via the coupling interface 5 in order to form a vertical stack with the at least one system box 30 in such a way that the saw device 10 assumes the transport orientation in the vertical stack, in which transport orientation the workpiece support 4 is vertically oriented with its support plane. In the transport orientation, the support plane of the workpiece support 4 is oriented vertically.

In the transport orientation, the workpiece support 4 is oriented with its support plane perpendicular to a system box upper side 32 and/or a system box underside 33 of a system box 30 arranged in the vertical stack.

The vertically tension-proof coupling is a coupling that transmits force in the vertical direction. The vertically tension-proof coupling may also be referred to as vertically tension-resistant coupling our as vertical coupling. In particular, the vertically tension-proof coupling is a coupling that transmits a vertical tensile force. For example, the vertically tension-proof coupling is a coupling that acts as a fixed bearing (e.g. a fixed coupling in all spatial directions) and/or transmits forces in all spatial directions. In a case where the saw device 10 is placed on the system box 30, the vertically tension-proof coupling causes the system box 30 to be lifted along with the saw device 10 when the saw device 10 is lifted (e.g. when the saw device 10 is pulled upwards). In a case in which the system box 30 is placed on the saw device 10 and is coupled to the saw device 10 in a vertically tension-proof manner, the vertically tension-proof coupling has the effect that the saw device 10 is also lifted by lifting the system box 30 (e.g. when the system box 30 is pulled upwards).

The releasable, vertically tension-proof coupling is in particular a coupling that can be released without tools.

The system box 30 is in particular a transport box (e.g. a transport crate). The system box 30 has a system box coupling interface, with which the system box can be releasably coupled in a vertically tension-proof manner to a compatible system box - that is, in particular, to a further system box of the same system - in order to form a vertical stack. The system box 30 is cuboidal in shape. In an exemplary embodiment, the system box 30 comprises a system box lower part 35 (having a cuboid shape, for example) and a system box lid 34 attached to the system box lower part 35, in particular placed onto the system box lower part 35. The upper side of the system box lid 34 is the system box upper side 32. The underside of the system box lower part 35 is the system box underside 33.

Preferably, the cover structure 50 comprises the coupling interface 5. In particular, the coupling interface 5 is part of the cover structure 50. The cover structure 50 is expediently attachable to the saw unit 20 to place the saw device 10 in the transport configuration. In the transport configuration, the saw device 10 is couplable to the at least one system box 30 by the coupling interface 5 to form the stack together with the at least one system box 30.

Exemplarily, the coupling interface 5 comprises a lower coupling interface 5A and/or an upper coupling interface 5B. Preferably, the coupling interface 5 consists of the lower coupling interface 5A and the upper coupling interface 5B. With the lower coupling interface 5A, the saw device 10 can be coupled in a releasable, vertically tension-proof manner to a lower system box 30A, onto which the saw device 10 is placed. With the upper coupling interface 5B, the saw device 10 can be coupled in a releasable, vertically tension-proof manner to an upper system box 30B placed on the saw device 10.

The lower coupling interface 5A is arranged at the first cover structure transverse side 25, in particular partially or completely. The upper coupling interface 5B is arranged on the second cover structure transverse side 26, in particular partially or completely.

The coupling interface 5 expediently comprises a plurality of coupling sections. The coupling sections expediently comprise one or more fixed (e.g. non-movable) coupling sections, for example one or more coupling recesses and/or one or more coupling protrusions. Expediently, the coupling interface 5 further comprises at least one (exemplarily exactly one) movable (e.g. movably supported) coupling section, for example a coupling latch. The coupling latch is designed in particular as a rotary latch, exemplarily as a T-shaped rotary latch.

Exemplarily, the upper coupling interface 5A comprises a plurality of upper coupling sections arranged in particular on the second cover structure transverse side 26 and/or the cover structure upper side 21. Exemplarily, the upper coupling sections comprise coupling recesses 36 arranged in particular on the second cover structure transverse side 26. In an exemplary embodiment, the upper coupling sections comprise a rotary latch 37 arranged in particular on the cover structure upper side 21.

Exemplarily, the lower coupling interface 5A comprises a plurality of lower coupling sections arranged in particular on the first cover structure transverse side 25 and/or the cover structure upper side 21. Exemplarily, the lower coupling sections comprise lower coupling protrusions 38 arranged in particular on the first cover structure transverse side 25 and designed, for example, as stand feet. Expediently, the lower coupling sections comprise a front coupling protrusion 39 arranged in particular on the cover structure upper side 21.

The coupling interface 5 is expediently designed to be couplable to an identical coupling interface; in particular, the lower coupling sections of the coupling interface 5 are couplable to upper coupling sections of an identical coupling interface. For example, the lower coupling protrusions 38 of the coupling interface 5 can be brought into engagement with coupling recesses of an identical coupling interface and/or the front coupling protrusions 39 can be brought into engagement with a rotary latch of the identical coupling interface.

FIG. 3 illustrates a stack arrangement 40. The stack arrangement 40 is an exemplary embodiment of the vertical stack. The stack arrangement 40 includes the saw device 10 and a lower system box 30A and/or an upper system box 30B. The system boxes 30A, 30B are examples of the system box 30; expediently, the explanations relating to the system box 30 apply respectively to the upper system box 30A and/or the lower system box 30B.

The saw device 10 is placed on the lower system box 30A and/or the upper system box 30B is placed on the saw device 10 so that the saw device 10, the lower system box 30A and/or the upper system box 30B together form a vertical stack.

Expediently, the coupling interface 5 comprises the lower coupling interface 5A providing a lower releasable, vertically tension-proof coupling to the lower system box 30A. Preferably, the coupling interface 5 comprises the upper coupling interface 5B, which provides an upper releasable, vertically tension-proof coupling to the upper system box 30B. In the vertical stack, the saw device 10 assumes the transport orientation in which the workpiece support 4 is vertically oriented with its support plane.

The vertical stack extends vertically upwards in a vertical stacking direction 46. In the transport orientation, the negative x-direction of the saw device 10 corresponds to the stacking direction 46. The vertical stack is expediently cuboid-shaped. The base area (e.g. the footprint) of the vertical stack is expediently equal to the x-z dimensions of the saw device 10. In particular, the saw device 10 (in the transport orientation) and the lower system box 30A and/or the upper system box 30B each have the same horizontal dimensions.

The system box 30, in particular the lower system box 30A and/or the upper system box 30B, comprises a system box coupling interface having an upper system box coupling interface for coupling the system box 30 to the lower coupling interface 5A and a lower system box coupling interface for coupling the system box to the upper coupling interface 5B. The system box coupling interface is expediently designed to correspond to the coupling interface 5.

Exemplarily, the upper system box coupling interface includes a plurality of upper system box coupling sections disposed in particular on the system box upper side 32 and/or a system box front side 41. Exemplarily, the upper system box coupling sections comprise system box coupling recesses 42 disposed in particular on the system box upper side 32. In an exemplary embodiment, the upper system box coupling sections include a system box rotary latch 43 disposed in particular on the system box front side 41.

Exemplarily, the lower system box coupling interface comprises a plurality of lower system box coupling sections arranged in particular on the system box underside 33 and/or the system box front side 41. Exemplarily, the lower system box coupling sections comprise lower system box coupling protrusions 44 arranged particularly on the system box underside 33 and designed, for example, as stand feet. Expediently, the lower system box coupling sections comprise a front system box coupling protrusion 45, which is arranged in particular on the system box front side 41.

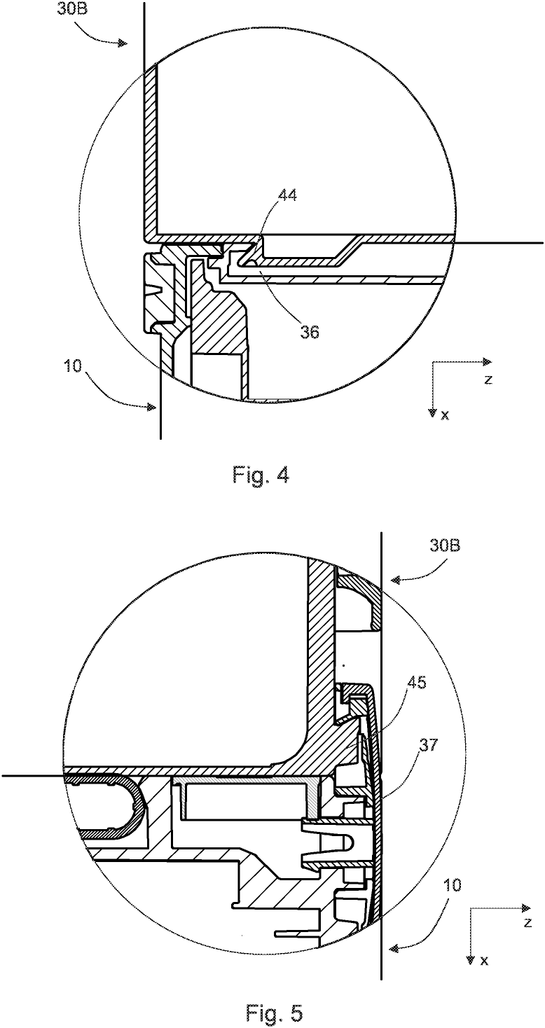

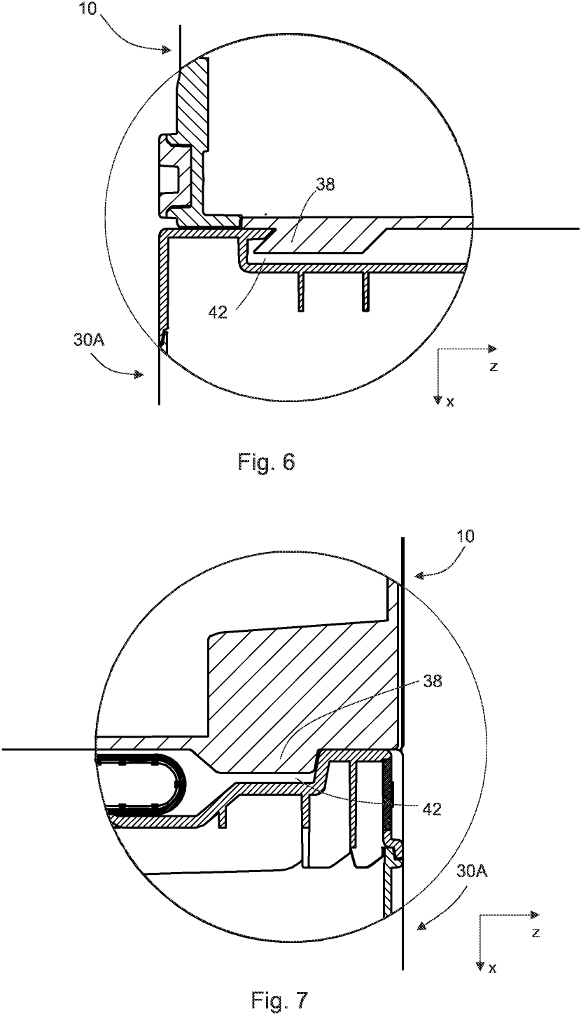

FIGS. 4 through 7 show details of the releasable, vertical tension coupling. In FIG. 4, a lower system box coupling protrusion 44 of the upper system box 30B is shown engaging a coupling recess 36 of the saw device 10. In FIG. 5, it is shown how a front system box coupling protrusion 45 engages a rotary latch 37 of the saw device 10. In FIGS. 6 and 7, it is shown how lower coupling protrusions 38 of the saw device 10 engage system box coupling recesses 42 of the lower system box 30A.

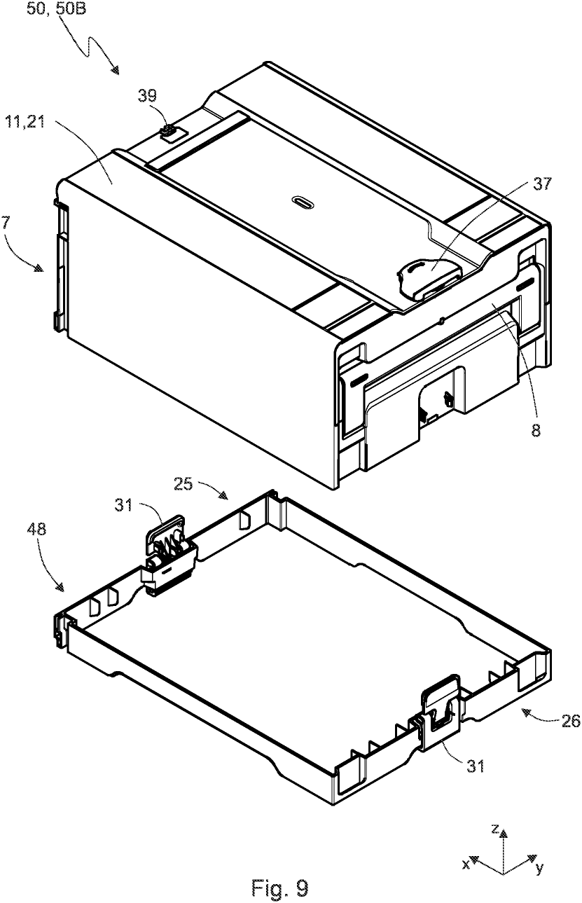

Preferably, the cover structure 50 comprises a workpiece support section 7. An exemplary embodiment of the workpiece support section 7 is shown in FIGS. 8 and 9. The saw device 10 can be put into a working configuration in which the workpiece support section 7 provides an additional support 11 which serves to provide, together with the workpiece support 4, a total workpiece support surface on which the workpiece 6 can be placed while the workpiece 6 is being sawn by the saw device 10. The total workpiece support surface is the sum of the support surface of the workpiece support 4 and the support surface of the additional support 11. Expediently, in the working configuration, the saw unit 20 stands with its underside 3 on the base 12 and the workpiece support section 7 is arranged next to the saw unit 20 so that the additional support 11 is arranged at the same height as the workpiece support 4. Preferably, the vertical distance from the underside 3 to the support plane of the workpiece support 4 is equal to the vertical distance of an underside of the workpiece support section 7 (with which underside the workpiece support section can be placed on the base 12) to a support plane of the additional support 11. Expediently, the workpiece support section 7 has a height which is identical to the distance from the underside 3 - i.e. the contact surface - of the saw device to the workpiece support 4. The workpiece support section 7 results in an overall larger surface - namely the total workpiece support surface - for supporting the workpiece 6 when sawing the workpiece 6 with the saw blade 1.

Exemplarily, in the working configuration, the workpiece support section 7 is arranged next to the saw unit 20 in the y-direction. It is also conceivable that, in the working configuration, the workpiece support section 7 is arranged in the x-direction next to the saw unit 20. Expediently, the workpiece support section 7 stands on the base 12. In particular, the base is designed to be flat. Exemplarily, the workpiece support section 7 is a hood-shaped section of the cover structure 50. Alternatively, the entire cover structure may serve as the workpiece support section 7. Preferably, the cover structure upper side 21 provides the additional support 11. In particular, the additional support 11 is an additional support surface. The workpiece 6 can be placed simultaneously on the workpiece support 4 and the additional support 11, in particular in a planar manner, while it is being sawn with the saw blade 1.

Optionally, the saw unit 20 has a parallel stop 47 (e.g. a rip fence), which in FIG. 8 is arranged on the workpiece support 4 by way of example and can be removed therefrom so that a workpiece can be placed on the workpiece support 4 in such a way that it also rests on the additional support 11 at the same time.

The cover structure 50 is preferably made of multiple parts. The workpiece support section 7 is removable from the remaining cover structure to provide the working configuration. FIG. 9 shows an exemplary embodiment of the cover structure 50, in which the cover structure 50 comprises the (exemplary hood-shaped) workpiece support section 7 and a cover structure lower part 48. The cover structure lower part 48 exemplarily forms the aforementioned remaining cover structure.

The cover structure 50 which comprises the workpiece support section 7 and the cover structure lower part 48 shall also be referred to as the cover structure 50B according to a second variant.

In an exemplary embodiment, the cover structure 50 is cuboidal; preferably, all sides of the cover structure 50 are closed, in particular in a state in which the cover structure lower part 48 is attached to the workpiece support section 7. The (in particular) cuboid cover structure 50 is exemplarily divided into the workpiece support section 7 and the cover structure lower part 48 by an imaginary horizontal dividing plane - that is, a dividing plane lying in the x-y plane. The imaginary horizontal dividing plane expediently runs parallel to the underside 3 - that is, in particular parallel to the contact surface - of the saw device 10. The imaginary horizontal dividing plane runs in particular through the lower half of the z-extension of the cover structure 50. Expediently, the z-extension of the cover structure lower part 48 is at most one third of the z-extension of the workpiece support section 7. Preferably, the cover structure 50 comprises cover structure fastening elements 31, which in particular comprise one or more fastening latches arranged exemplarily on the cover structure lower part 48. The cover structure fastening elements 31 are arranged on the cover structure transverse sides 25, 26 in an exemplary manner.

Optionally, the workpiece support section 7 is connectable to the saw device 10 and/or the base 12, for example a workbench, in particular can be fastened thereto, expediently in such a way that the workpiece support section 7 is fixed relative to the saw unit 20 and thus cannot slip. For example, the base 12, in particular the workbench, has recesses into which the saw unit 20 (in particular with its stand feet) and/or the workpiece support section 7 can engage. For example, the base 12 has a hole structure, in particular a blind hole structure, which provides the recesses. For example, the workpiece support section 7 has engagement structures to engage the recesses of the base 12. The engagement structures are, for example, stand feet that are, in particular, identical to the stand feet of the saw unit 20. Optionally, the workpiece support section 7 may include one or more hooks for engaging it with the workpiece support 4. Optionally, the saw device 10 comprises a clamping device with which the workpiece support section 7 can be fastened to the saw unit 20.

In particular, the saw device 10 is operable by a method comprising the step of: establishing the releasable, vertically tension-proof coupling between the saw device 10 and the at least one system box 30, such that the saw device 10 and the at least one system box 30 form the vertical stack, such that the saw device 10 in the vertical stack assumes the transport orientation in which the workpiece support 4 is vertically oriented with its support plane.

For example, the saw device 10 is initially in the working configuration and working orientation. The saw unit 20 is expediently positioned with its underside 3 on an in particular horizontally oriented base. The workpiece support 4 is oriented horizontally with its support plane. The cover structure 50 is expediently completely removed from the saw unit 20. Exemplarily, in the working configuration, a sawing step is carried out in which the workpiece 6 is sawn with the saw blade 1. The sawing step is then terminated. Expediently, the cover structure 50 is slipped over the saw unit 20 (in particular by a user) and is expediently attached to the saw unit 20 (in particular by a user) to put the saw device 10 in the transport configuration. The saw device 10 is then lifted (particularly by the user) and rotated 90 degrees about a horizontal axis so that the saw device assumes the transport orientation. In the transport orientation, the first cover structure transverse side 25 and the second cover structure transverse side 26 are oriented horizontally and the workpiece support 4 is oriented vertically with its support plane. The saw device 10 is then placed with its first cover structure transverse side 25 on the lower system box 30A and attached to the lower system box 30A with the lower coupling interface 5A. Preferably, the upper system box 30B is then placed on the second cover structure transverse side 26 and attached to the upper coupling interface 5B.

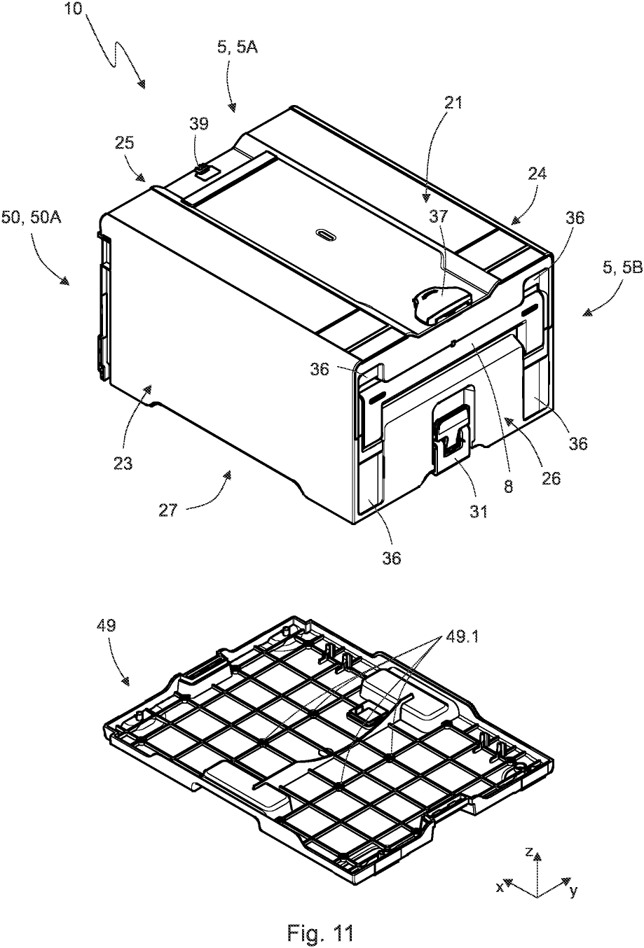

Referring now to FIG. 11, a cover arrangement 70 will be discussed below.

The cover arrangement 70 comprises a cover structure 50 designed as a protective hood for receiving a power tool, in particular a circular table saw or a miter saw (e.g. a cross-cut saw). The power tool may be the saw unit 20 or a power tool other than a saw device - that is, in particular, not a saw device. In particular, the power tool is a semi-stationary machine. Expediently, the protective hood is designed like the above explained cover structure 50A according to the first variant, so that the above explanations related thereto also apply to the protective hood. In particular, the protective hood is of cuboidal design, wherein expediently the cover structure underside 27 is of open design and preferably the other sides 21, 23, 24, 25, 26 are closed sides. Exemplarily, the protective hood has the carrying handle 8 arranged on the second cover structure transverse side 26.

The protective hood has the coupling interface 5. The coupling interface 5 is designed in particular as explained above. With the coupling interface 5, a releasable, vertically tension-proof coupling to one or more system boxes 30 can be established, so that the cover arrangement 70 can form a vertical stack together with the one or more system boxes 30 in a transport configuration in which the protective hood accommodates the power tool.

Preferably, the coupling interface 5 comprises the lower coupling interface 5A, with which, in a state in which the protective hood is placed on the lower system box 30A, a lower releasable, vertically tension-proof coupling to the lower system box 30A can be established. Expediently, the coupling interface 5 comprises the upper coupling interface 5B, with which, in a state in which the upper system box 30B is placed on the protective hood, an upper releasable, vertically tension-proof coupling to the upper system box 30B can be established.

Preferably, the cover arrangement 70 comprises a bottom element 49 attachable to the cover structure 50 to close the open cover structure underside 27. In a state in which the bottom element 49 is attached to the cover structure 50, the cover arrangement 70 is expediently cuboidal, wherein in particular all sides of the cover arrangement 70 are closed. Exemplarily, the cover structure fastening elements 31 of the cover structure 50, which are in particular configured as fastening latches, serve to attach the bottom element 49 to the cover structure 50. In particular, the bottom element 49 is designed as a bottom plate. Preferably, the bottom element 49 and the protective cover together form a system box, in particular an outwardly closed system box, when the bottom element 49 is attached to the protective cover.

Preferably, the protective hood comprises recesses on one end face - in particular the coupling recesses 36 - for a positive (e.g. form-locking) connection with a system box 30 which can be placed thereon and can be releasably secured to the protective hood with its system box rotary latch 43. The end face is the second cover structure transverse side 26 and, in a state in which the protective hood is accommodated in the vertical stack, faces upwards - is thus oriented horizontally.

The protective hood expediently has further coupling elements - for example the cover structure fastening elements 31 - for coupling, in particular for detachable fastening, of an element closing the protective hood and/or the bottom plate of the power tool. These coupling elements are in particular arranged on the outside of the protective hood. These coupling elements can also be referred to as primary coupling elements and can in particular be operated from outside the protective hood.

Preferably, the protective cover has internally arranged coupling elements - for example, the internal coupling structure 9 - in particular one or more hooks, for releasable connection of the power tool to the protective cover, in particular in the transport orientation of the protective cover. In the transport orientation, the cover structure transverse sides 25, 26 are oriented horizontally - that is, perpendicular to the vertical. These coupling elements can also be referred to as secondary coupling elements and serve to improve force absorption during transport and/or carrying of the protective hood, so that the weight force of the power tool transported in the protective hood is transferred not only via the primary coupling elements, but also simultaneously via the secondary coupling means to the protective hood, in particular to the carrying handle 8.

Optionally, an underside and/or contact surface of the power tool forms the bottom plate of the cover arrangement 70 when the power tool is received in the protective hood.

Expediently, a transport arrangement 60 is provided comprising the cover arrangement 70 and the power tool accomodated in the protective cover. The transport arrangement 60 has the coupling sections for establishing the releasable, vertically tension-proof coupling, in particular the lower releasable, vertically tension-proof coupling and/or the upper releasable, vertically tension-proof coupling. In particular, the coupling sections are formed like the coupling sections explained above. The coupling sections are part of the coupling interface 5. Preferably, all coupling sections are part of the protective hood and not part of the power tool.

Preferably, the cover arrangement 70 has the bottom element 49, which in particular is not part of the power tool. Preferably, the power tool is connected to the bottom element, in particular releasably, by means of clamping or screw elements. For example, the bottom surface (e.g. the contact surface) of the power tool is clamped, braced or screwed to the bottom plate or bottom element 49. Optionally, the power tool is a hand-held tool, for example a long-neck grinder, and is expediently clamped and/or braced to the bottom plate.

Optionally, the bottom element 49, which is designed in particular as a bottom plate, has a tool-receiving area that can be flexibly adapted to a power tool to be fastened. For example, the tool-receiving area comprises a plurality of recesses 49.1 into which fastening elements for the power tool to be fastened are inserted and secured (for example by screws and/or positive locking). Expeidently, the fastening elements may be arranged in different recesses in order to adapt the tool-receiving area to the respective tool to be fastened.

FIG. 3 shows a stack arrangement 40 comprising the transport arrangement 60, and the lower system box 30A and the upper system box 30B. The transport arrangement 60 is mounted on the lower system box 30A, and the upper system box 30B is mounted on the transport arrangement 60, such that the transport arrangement 60, the lower system box 30A, and the upper system box 30B together form a vertical stack. The coupling interface 5 includes the lower coupling interface 5A providing a lower releasable, vertical tension-proof coupling to the lower system box 30A, and the upper coupling interface 5A providing an upper releasable, vertical tension-proof coupling to the upper system box 30B.

In the vertical stack, the cover structure 50 is expediently oriented vertically with its cover structure underside 27. In particular, the first cover structure transverse side 25 and the second cover structure transverse side 26 are oriented horizontally, that is, in particular, perpendicular to the stacking direction 46. For example, the first cover structure transverse side 25 rests on the system box upper side of the lower system box 30A and on the second cover structure transverse side 26 rests the system box lower side of the upper system box 30B.

1. A saw device comprising a saw unit, the saw unit comprising:
a saw blade and a support structure which is positionable with an underside on a base and has a workpiece support on which a workpiece is positionable when the workpiece is being sawn with the saw device,
the saw device having a coupling interface via which a releasable, vertically tension-proof coupling is able to be established with at least one system box in order to form a vertical stack together with the at least one system box in such a way that the saw device assumes a transport orientation in the vertical stack, in which transport orientation the workpiece support is oriented vertically with its support plane.

2. The saw device of claim 1, further comprising a cover structure attachable to the saw unit to put the saw device in a transport configuration in which the saw device is coupleable via the coupling interface to the at least one system box to form the vertical stack together with the at least one system box.

3. The saw device according to claim 2, wherein the cover structure comprises the coupling interface.

4. The saw device according to claim 2, wherein, in the transport configuration, the cover structure delimits an interior space which is closed with respect to the environment of the saw device and in which interior space the saw blade and/or the workpiece support is arranged.

5. The saw device according to claim 2, wherein the cover structure comprises a cover hood.

6. The saw device according to claim 2, wherein, in the transport configuration, the saw device has a cuboid outer housing partially or completely formed by the cover structure.

7. The saw device according to claim 6, wherein, in the transport configuration, one side of the cuboid outer housing is formed by the underside of the support structure and all other sides of the outer housing are formed by the cover structure.

8. The saw device according to claim 2, wherein the cover structure comprises a workpiece support section and the saw device is settable into a working configuration in which the workpiece support section provides an additional support, which serves to provide, together with the workpiece support, an overall workpiece support surface onto which the workpiece is positionable, in particular in a planar manner, while the workpiece is being sawn with the saw device.

9. The saw device according to claim 8, wherein, in the working configuration, the saw unit stands with its underside on the base and the workpiece support section is arranged next to the saw unit so that the additional support is arranged at the same height as the workpiece support.

10. The saw apparatus according to claim 8, wherein the cover structure is made in multiple parts and the workpiece support section is detachable from the remaining cover structure to provide the working configuration.

11. The saw device according to claim 2, wherein the cover structure comprises an internal coupling structure via which the saw unit is suspended from the cover structure when the saw device is in the transport orientation.

12. The saw device according to claim 11, wherein the cover structure comprises a carrying handle arranged in the area of the inner coupling structure on the outside of the cover structure.

13. A stack arrangement comprising the saw device according to claim 1, and a lower system box and/or an upper system box, wherein the saw device is placed on the lower system box and/or the upper system box is placed on the saw device such that the saw device, the lower system box and/or the upper system box together form a vertical stack, and wherein the coupling interface comprises a lower coupling interface providing a lower releasable, vertically tension-proof coupling to the lower system box and/or comprises an upper coupling interface providing an upper releasable, vertically tension-proof coupling to the upper system box, the saw device assuming in the vertical stack the transport orientation in which the workpiece support is vertically oriented with its support plane.

14. A method of operating the saw device according to claim 1, comprising the step of:
establishing the releasable, vertically tension-proof coupling between the saw device and the at least one system box such that the saw device and the at least one system box form the vertical stack such that the saw device in the vertical stack assumes the transport orientation in which the workpiece support is vertically oriented with its support plane.

15. A cover arrangement with a cover structure configured as a protective hood for accommodating a power tool, the protective hood having a coupling interface with which a releasable, vertically tension-proof coupling to one or more system boxes can be established, so that the cover arrangement is configured to, in a transport configuration in which the protective hood accommodates the power tool, form a vertical stack together with the one or more system boxes.

16. The cover arrangement according to claim 15, wherein the coupling interface comprises a lower coupling interface with which, in a state in which the protective cover is placed on a lower system box, a lower releasable, vertically tension-proof coupling to the lower system box can be established, and/or an upper coupling interface with which, in a state in which an upper system box is placed on the protective hood, an upper releasable, vertically tension-proof coupling to the upper system box can be established.

17. A transport arrangement comprising the cover arrangement of claim 15 and the power tool arranged in the protective hood, wherein the transport arrangement has coupling sections for establishing the releasable, vertically tension-proof coupling, which coupling sections are part of the coupling interface, wherein all coupling sections are part of the protective hood and not part of the power tool.

18. A stack arrangement comprising a transport arrangement according to claim 17, and a lower system box and an upper system box, wherein the transport arrangement is mounted on the lower system box and the upper system box is mounted on the transport arrangement such that the transport arrangement, the lower system box and the upper system box together form a vertical stack, and wherein the coupling interface comprises a lower coupling interface providing a lower releasable vertically tension-proof coupling to the lower system box and an upper coupling interface providing an upper releasable vertically tension-proof coupling to the upper system box.

19. A method of operating the transport arrangement of claim 17, comprising the step of: establishing the releasable, vertically tension-proof coupling of the protective cover to the at least one system box to form the vertical stack.

20. The saw device according to claim 1, wherein the saw device is a circular table saw or a miter saw.
